(19) United States
(12) Patent Application Publication
(10) Pub. No.: US 2004/0096226 A1
(43) Pub. Date: May 20, 2004

(54) Method and device for receiving a signal in optical cdma system

(76) Inventors: Olli-Pekka Hiironen, Espoo (FI); Markku Tahkokorpi, Espoo (FI)

Correspondence Address: HARRINGTON & SMITH, LLP, 4 RESEARCH DRIVE, SHELTON, CT, 06484-6212, US

(21) Appl. No.: 10/363,018

(22) PCT Filed: Jul. 1, 2002
(86) PCT No.: PCT/FI02/00585

(30) Foreign Application Priority Data
Jun. 29, 2001 (FI) 20011418

(51) Int. Cl. H04B 10/06

(52) U.S. Cl. 398/202; 398/212; 398/161; 398/99

(57) ABSTRACT

A method and a device for receiving a broadband light pulse modified in the time and frequency domains, the light pulse comprising at least one frequency component. The method comprises receiving the light pulse at a particular moment, separating the frequency components of the light pulse from each other, converting each frequency component into an electrical pulse, performing a first comparison to compare the magnitude of each electrical pulse to a predetermined threshold value, performing a second comparison to compare said electrical pulses exceeding the threshold value at a particular moment, and deciding the bit value in response to the second comparison conducted.

The present invention relates to a method and a device for receiving a signal in an optical CDMA system, and particularly, but not necessarily, in optical frequency hopping and optical spectral coding CDMA systems.

### TECHNICAL BACKGROUND

An optical CDMA (Optical Code Division Multiple Access, OCDMA) is a system that enables the large bandwidth of an optic fibre network to be divided with no need for complex electronic signal processing. Several methods and combinations thereof exist for implementing the OCDMA that may employ a coherent, incoherent, synchronous or an asynchronous system. In addition, the system can be based on time or frequency coding, or frequency hopping comprising time and frequency coding.

Typically, it has been a difficult task for OCDMA systems to detect an optical signal to be received. In On-Off Keying (OOK), a signal is detected by comparing a signal level to a threshold value at a particular moment. A 1-bit is detected if the signal level is higher than the threshold level, and, correspondingly, a 0-bit is detected if the signal level is lower than the threshold level.

In the OCDMA systems, the signals to be received are subjected to interference by noise, such as beat noise, receiver noises, thermal noise and Multi-Access Interference (MAI). In order to achieve an appropriate Bit-Error-Rate (BER), the difference between the 1- and 0-bits, i.e. the Signal-to-Interference Ratio (SIR), has to be adequately high. In the OCDMA systems, the SIR depends on the weight of the code used; the weight describes e.g. the number of frequency components (frequency bins) in the particular code. The multi-access interference MAI also affects the signal-to-interference ratio.

A known solution to the problem is an OCDMA receiver, which uses one photodiode to detect all frequency component pulses. Then, however, a proper signal-to-interference ratio is only achieved when the codes used are long (more time slots and/or more frequency bins) or when the system comprises few simultaneous users.

### SUMMARY OF THE INVENTION

A method and a device are provided for receiving an optical signal in an optical CDMA system. Received optical frequency component pulses are divided to branches of their own according to frequency, and in the branches each component is detected by separate detectors. Preferably, a photodetector, such as a photodiode, can be used for detecting an optical pulse, the photodetector simultaneously converting an optical pulse into an electrical one.

The invention enables a better bit error rate BER with the same signal-to-interference ratio SIR than the prior art solution. The invention thus enables more simultaneous users and simpler encoders (shorter codes) when the same bit error rate as in the prior art solution is used.

According to a first aspect of the invention, a method is implemented for generating an output bit value from a received optical pulse sequence comprising at least two pulse components with different frequencies, characterized in that the method comprises dividing said optical pulse sequence to at least two different frequency bands, each frequency band comprising at least one frequency pulse component from said optical pulse, converting the frequency pulse component of each frequency band into an electrical pulse, generating a bit value for each frequency band on the basis of the magnitude of the electrical pulse, and deciding the value of a received output bit on the basis of the bit value of each frequency band.

According to a second aspect of the invention, an electronic device is implemented for generating an output bit value from a received optical pulse sequence comprising at least two pulse components with different frequencies, characterized in that the device comprises division means for dividing said optical pulse sequence to at least two different frequency bands, each frequency band comprising at least one frequency pulse component from said optical pulse, conversion means for converting the frequency pulse component of each frequency band into an electrical pulse, first comparison means for comparing the magnitude of the electrical pulse of each frequency band to the magnitude of a predetermined threshold value, generation means for generating a bit value for each frequency band in response to the comparison conducted, and decision means for generating the value of a received output bit on the basis of the bit value of each frequency band.

In the following, the invention will be described in closer detail with reference to the accompanying drawings, in which

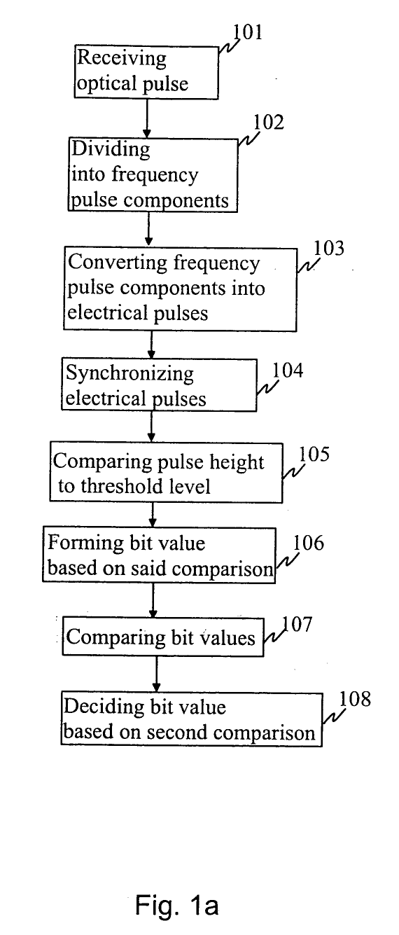

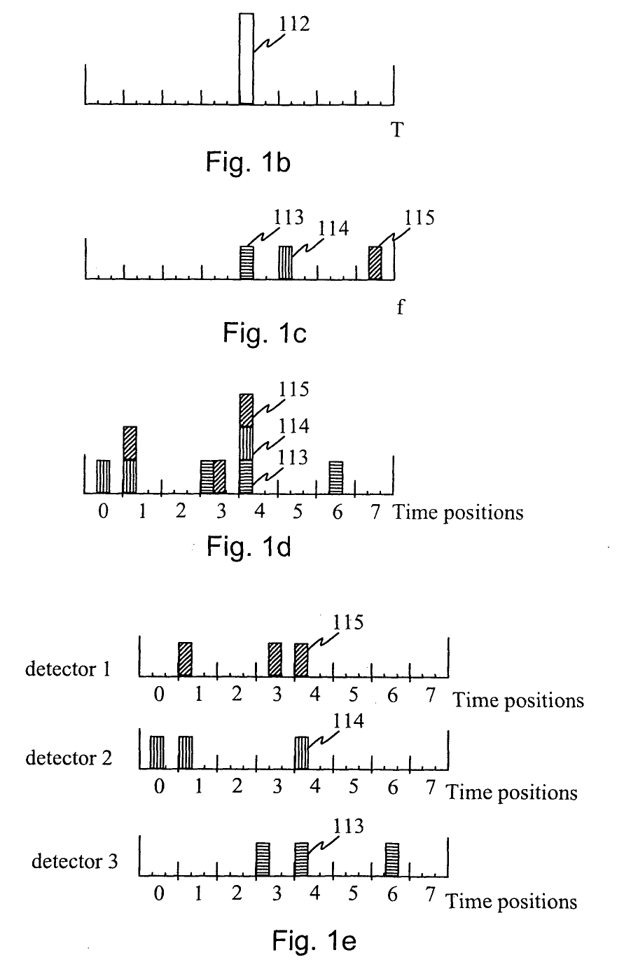

FIG. 1a is a flow diagram showing a method of the invention,

FIGS. 1b, 1c, 1d and 1e show how frequency pulses are generated from an optical pulse,

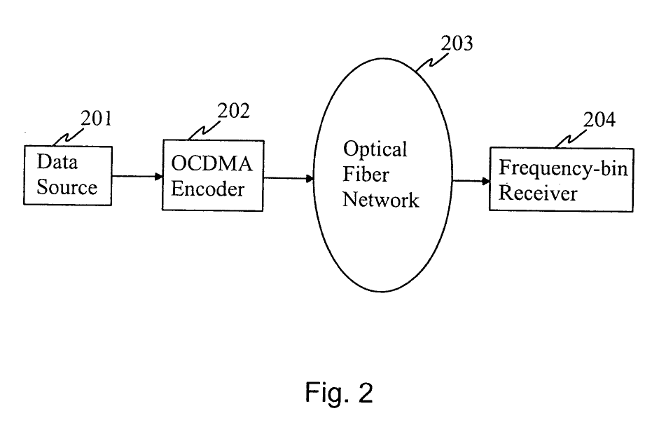

FIG. 2 shows a system according to an embodiment of the invention,

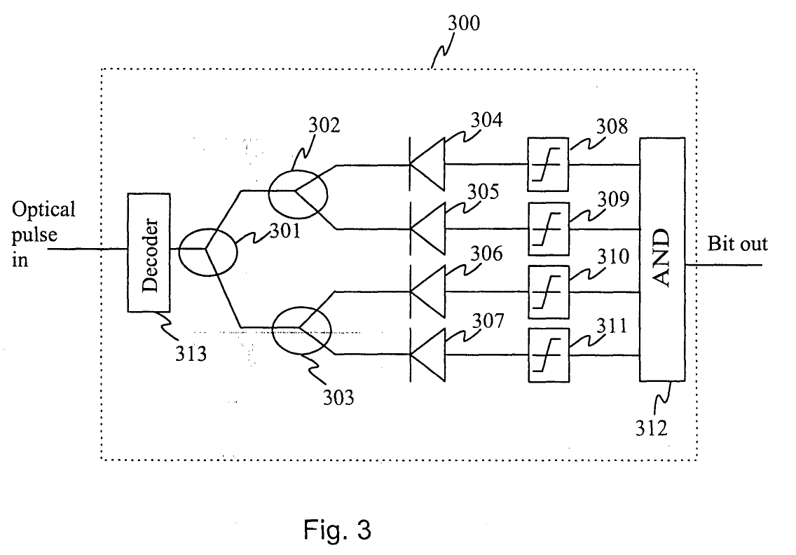

FIG. 3 shows a receiver according to an embodiment of the invention,

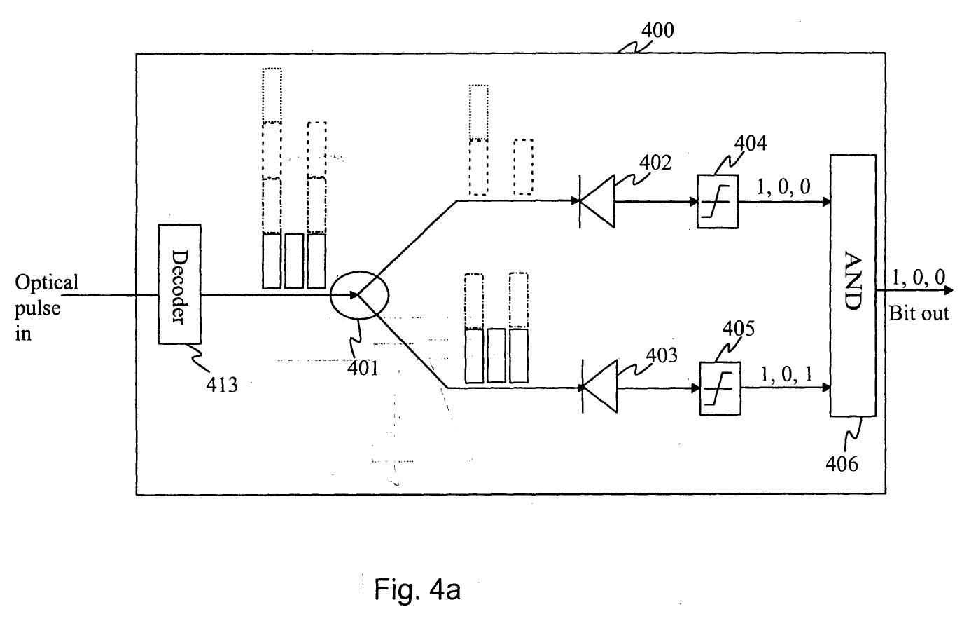

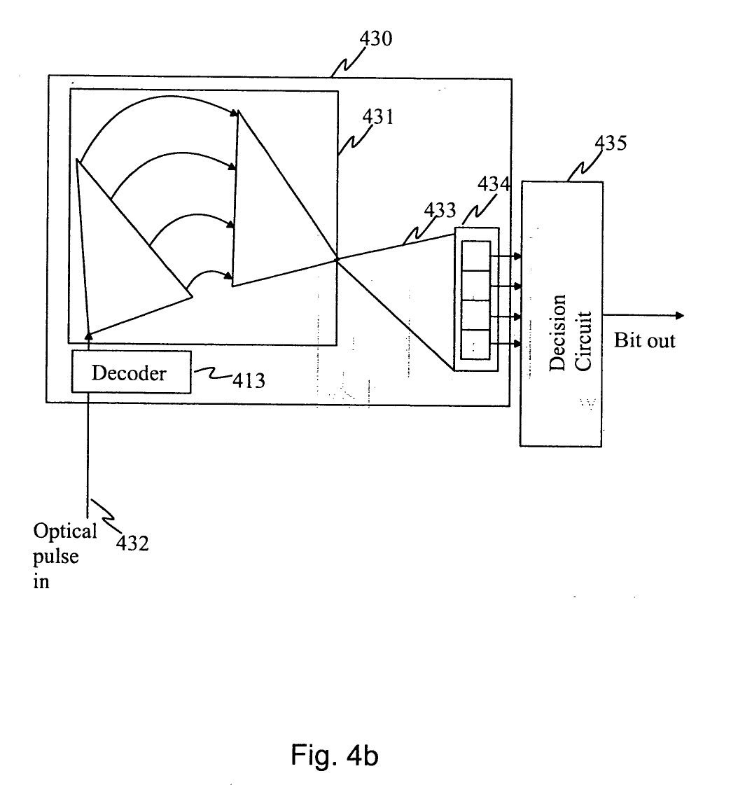

FIG. 4a shows an alternative embodiment of a frequency pulse receiver,

FIG. 4b shows a frequency pulse receiver employing integrated optics,

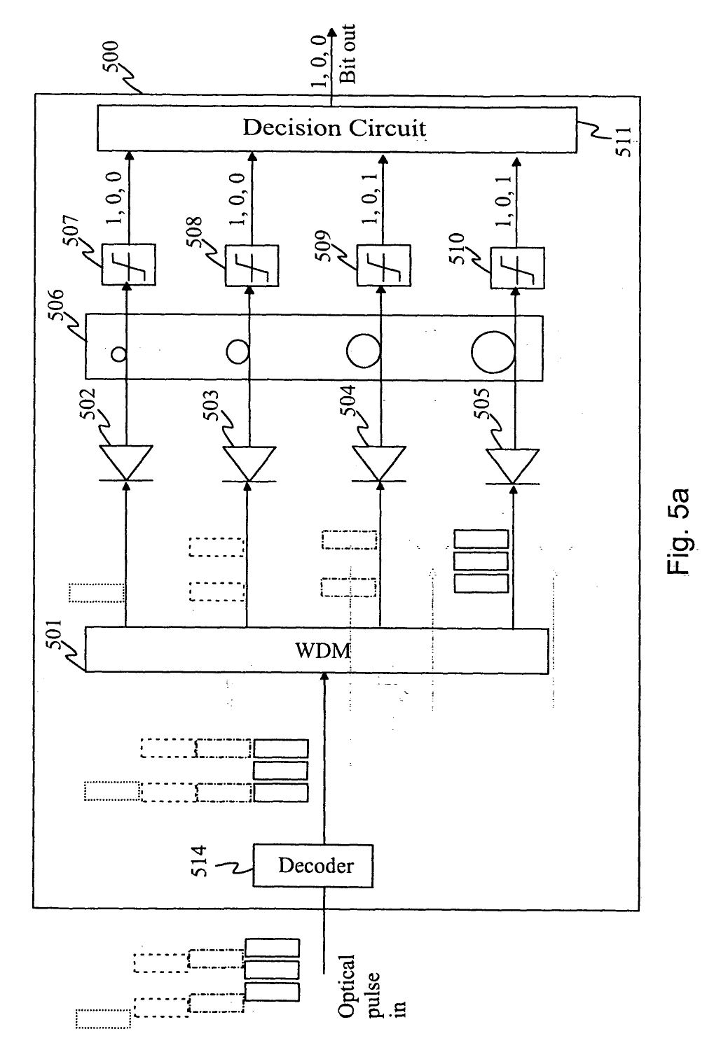

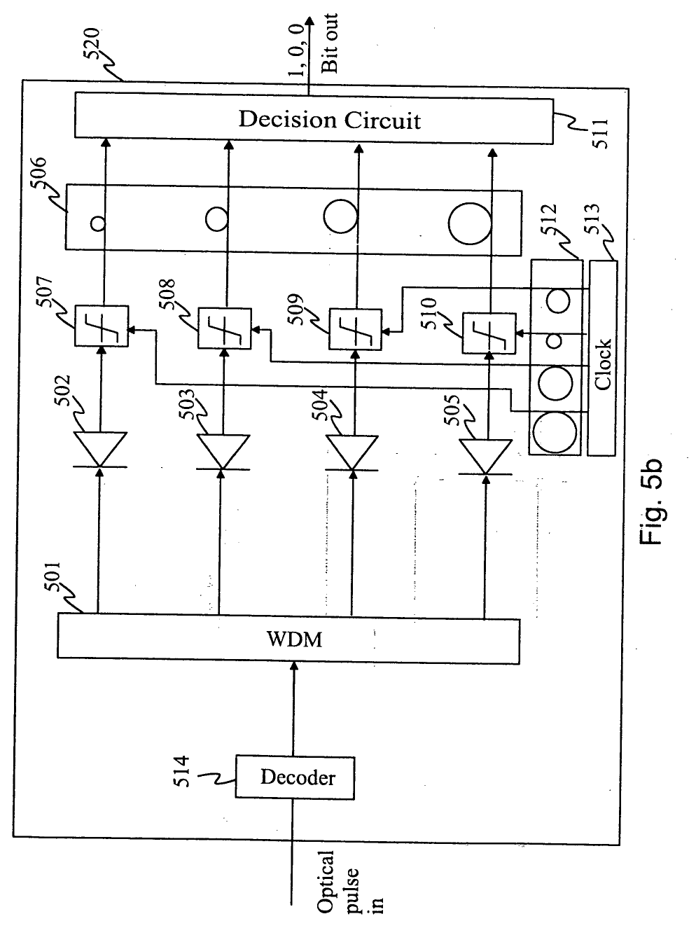

FIGS. 5a and 5b show a receiver according to an alternative embodiment of the invention, the receiver employing dispersion compensation, and

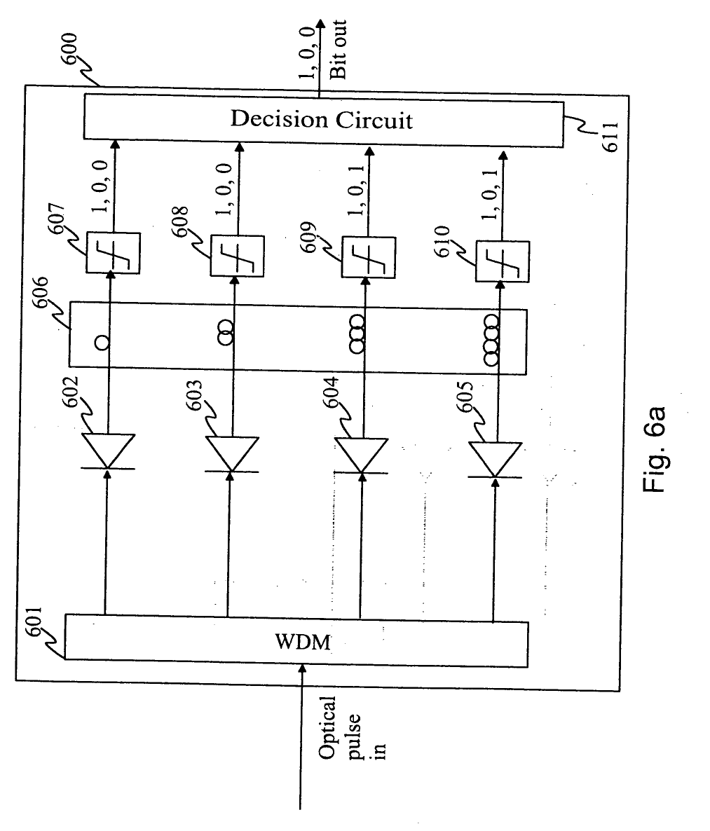

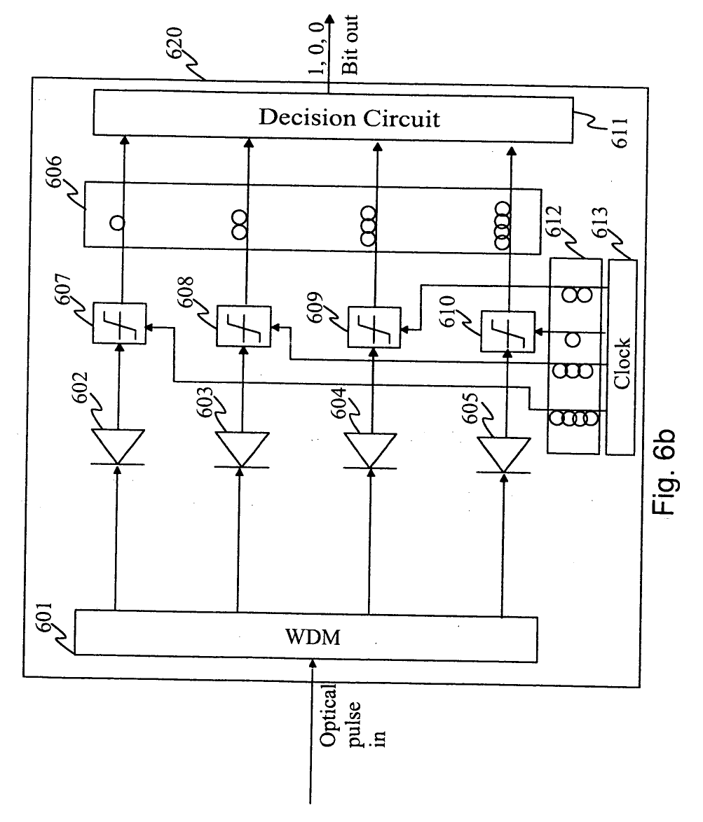

FIGS. 6a and 6b show a receiver according to an alternative embodiment of the invention, the receiver employing frequency hopping decoding.

FIG. 1a is a flow diagram showing a method of the invention. In the method, a bit value is generated from a received time- and frequency-domain-encoded optical pulse comprising at least two pulse components with different frequencies. In step 101, the optical pulse is received and decoded in the time domain, and in step 102 the pulse is divided to at least two different frequency bands, each frequency band comprising at least one parallel frequency pulse component from the optical pulse. In step 103, the optical frequency pulse component of each frequency band is converted into an electrical pulse. In step 104, the electrical pulse of each frequency band is synchronized with the same moment in the time domain. In step 105, the magnitude of the electrical pulse of each frequency band is separately compared to the magnitude of a predetermined threshold value. Steps 104 and 105 disclosed above can also be implemented such that step 105 is carried out first, followed by step 104. In step 106, a bit value is generated for each frequency band in response to the comparison conducted. In step 107, a second comparison is performed to compare at the same time the generated bit values of all frequency bands with each other. In step 108, a decision is made about the value of a received bit in response to the second comparison conducted. Alternatively, step 104 can be carried out e.g. in connection with steps 107 and 108 or therebetween.

FIGS. 1b, 1c, 1d and 1e show how frequency pulses are generated from an optical pulse. FIG. 1b shows an optical pulse 112 generated in a transmitter, the pulse being divided into two or more frequency component pulses (frequency bins) in the manner shown in FIG. 1c (references 113 to 115). Frequency component pulses are pulses, which have certain frequencies different from each other and which are located in different time slots and which are transmitted to a receiver through an optical fibre network. FIG. 1d shows frequency component pulses arriving at a receiver at different moments.

The frequency pulse components 113 to 115 of a signal of a particular user have been decoded to the same moment while the frequency pulse components received by other users have spread in the time domain. The frequency pulse components 113 to 115 arrive at the receiver substantially at the same moment if decoding has been carried out in connection with the reception. Based on frequency, the frequency component pulses are separated, and each frequency component is provided with a detector, e.g. a photodiode, of its own, as disclosed in FIG. 1e, the detector converting the optic pulse into an electrical one.

FIG. 2 shows a system according to an embodiment of the invention. A data source 201, which can be e.g. a LED light, generates a light pulse corresponding to a data bit to be transmitted, the light pulse being modified in the time and frequency domains in frequency hopping coding. In an encoder 202, the pulse is first divided e.g. into two frequency component pulses, i.e. frequency pulses (frequency bins), having different frequencies by means of a Wavelength-Division Multiplexer (WDM), which can be based e.g. on an inter-leaver (Arrayed Waveguide Grating AWG), Fibre Bragg Grating (FBG), or a filter. Alternatively, the pulse can also be divided into more than two frequency pulses. Each frequency pulse is delayed by delay lines according to the particular coding used in the time domain; and transmitted through an optical fibre network 203 to a receiver 204, wherein decoding and generation of a received bit are carried out.

FIG. 3 shows a frequency pulse receiver according to an embodiment of the invention. A receiver 300 comprises a decoder 313 for decoding frequency pulse components, one or more frequency selective components 301 to 303, such as a WDM, AGW, FBW or a filter, capable of separating at least two frequency pulses at different frequencies at the same moment. The pulse frequency may be e.g. 190 THz. The frequency-selective component can also detect more than two frequency pulses at the same moment. The frequency pulse components are received by photodiodes 304 to 307. The receiver 300 comprises at least one photodiode per each frequency pulse component. The photodiode converts the frequency pulse into an electrical pulse. The electrical pulse generated by each photodiode is received by a comparator 308 to 311, wherein the electrical pulse is compared to a predetermined threshold value, which can be a proportion, preferably half, of the maximum value of the signal pulse. If the magnitude of the pulse exceeds the predetermined threshold value, a 1-bit is transmitted to a decision circuit, and, correspondingly, if the magnitude of the pulse does not exceed the threshold value, a 0-bit is transmitted to the decision circuit. The decision circuit 312 is used for deciding the value of the bit transmitted from the transmitter on the basis of the received bits. The decision circuit may be e.g. an AND gate. In other words, the output is “0” if any one of the outputs 308 to 311 is “0”.

FIG. 4a shows an alternative embodiment for receiving a frequency pulse. The receiver comprises a decoder 413 for decoding frequency pulse components, at least one frequency-selective component 401 enabling the received frequency pulses to be separated from each other between at least two different frequency ranges. In the case of the example, the frequency-selective component 401 receives frequency pulses in four different frequency ranges, for instance two of the frequency pulses in a higher frequency range being supplied to a photodiode 402 and, correspondingly, two of the frequency pulses in a lower frequency range being supplied to a photodiode 403. A frequency range can be e.g. 100 GHz wide. A pulse may have a frequency of 190 THz, for example. From the received frequency pulse, the photodiode 402 (photodiode 403, correspondingly) generates an electrical pulse signal, which is further received by a comparator 404 (comparator 405, correspondingly). The comparator 404 (comparator 405, correspondingly) compares the magnitude of the received pulse signal to a predetermined threshold value. If the magnitude of the signal pulse exceeds the threshold value, e.g. a digital signal representing the 1-bit is transmitted to the decision circuit; otherwise, a signal representing the 0-bit is transmitted. The signals of the comparators 404 and 405 are received by a decision circuit 406, wherein the signal pulses received at a particular moment are compared, and if both signal pulses are 1-bits, the output of the decision circuit is provided with a 1-bit at said moment. Correspondingly, if one of the signals or both signals received by the decision circuit is/are 0-bits, the output of the decision circuit is provided with a 0-bit at said moment.

FIG. 4b shows a frequency pulse receiver comprising an integrated wavelength division multiplexer and photodetector combination 430 further comprising an input 422 for receiving a light signal pulse comprising frequency pulse components, a decoder 413 for decoding the frequency pulse components, a wavelength division multiplexer 431, a waveguide 433, and a photodetector matrix for separating the frequency pulses from each other. From the photodetector matrix, the pulse signal is further transmitted to a detection circuit 435, wherein a final decision is made about the value of the received bit by comparing the signal of each photodetector with each other at a particular moment. The system according to FIG. 4b can readily and cost-effectively be implemented on the same integrated circuit. By using sequential frequency-selective components, such as interleavers, in the frequency pulse receivers, corresponding receivers can also be used in different WDM channels, which is advantageous as far as both material and economical aspects are concerned.

FIG. 5a shows a device 500 according to an embodiment of the invention, the device employing dispersion compensation. The compensation is based on delay lines 506 located in each branch of the receiver receiving a frequency pulse. The system is suitable for use e.g. in OCDMA systems employing frequency hopping and spectral coding.

Dispersion in an optical fibre is caused by signals with different frequencies propagating at different speeds in the fibre. In the OCDMA system, dispersion widens the pulse as it propagates in the optical fibre. The pulse widens proportionately to the distance propagated and to the pulse frequency, which limits the length of the transmission path and makes the pulse more difficult to be detected in the receiver.

The influence of dispersion in the OCDMA system can be diminished by compensation in the receiver. The compensation enables the frequency pulses to be wider, which means that the proportion of noise, such as thermal and beat noise, can be decreased in the receiver. In addition, more frequency pulses can be used in coding, which enables smaller codes and, therefore, more users and a more powerful broadband source.

The frequency pulse receiver 500 detects each single frequency pulse and counts how many frequency pulses are received at a particular moment. The received frequency pulses are decoded in a decoder 514, and divided to photodiodes 502 to 505 according to frequency e.g. by a WDM 501 operating as a frequency-selective multiplexer. The photodiodes 502 to 505 convert each frequency pulse into a corresponding electrical pulse, which is compared by comparators 507 to 510 to a predetermined threshold value. The comparator 507 to 510 transmits a pulse corresponding to the 1-bit to a decision circuit 511 if the signal to be compared exceeds the threshold value, and, correspondingly, a pulse corresponding to the 0-bit if the signal to be compared does not exceed the threshold value. The decision circuit 511 decides the value of the bit transmitted from a transmitter on the basis of the received bits. The decision circuit may be e.g. an AND gate. In other words, the output is “0” if any one of the outputs 308 to 311 is “0”. Since the frequency pulses do not arrive at the receiver at the same time, due to dispersion, the dispersion must be compensated for among the frequency pulses such that the decision circuit receives signals belonging to the same moment at the same time. The compensation can be implemented e.g. by arranging a delay line 506 in each branch e.g. between a photodiode and a comparator to enable the phase deviation between a particular frequency pulse propagating in each branch and other corresponding frequency pulses to be minimized.

The delay line can be e.g. a certain length of an optical fibre and, in addition to what has been disclosed above, it can, alternatively, also be located between the frequency-selective component 501 and each photodiode 502 to 505.

Another delay line 512 can also be arranged between a synchronizer 513 of the comparators and each comparator 507 to 510 as shown in FIG. 5b. Since in this case the frequency pulses do not arrive at the decision circuit 511 simultaneously, the system requires the other delay line 506 also to be arranged between the comparators 507 to 510 and the decision circuit 511.

FIG. 6a shows a device 600 according to an embodiment of the invention, the device employing frequency hopping decoding carried out in the frequency pulse receiver. No separate OCDMA decoder is thus needed. Alternatively, decoding can be implemented employing tunable electrical delay lines 606 arranged between photodiodes and comparators.

In the frequency pulse receiver, the frequency-selective component 601 (e.g. a WDM) separates the frequency pulse of each received encoded frequency pulse sequence to its own branch on the basis of the pulse frequency. In each branch, a photodiode 602 to 605 receives an optical pulse and converts it into an electrical one. After the conversion, the sequence is decoded by adding optical delay lines 606 based on encoding to each branch, thus enabling the frequency pulse components originating from a light pulse supplied from a particular transmitter to be simultaneous. The delay lines may be e.g. tunable, which makes the codes easier to change. The decoded frequency pulses arrive at a decision circuit 611, and a correct decision about the value of the received bit can be made.

Another alternative way to implement decoding is shown in FIG. 6b wherein tunable delay lines 612 are further arranged between the comparators and the decision circuit. Since in this case the frequency pulses do not arrive at the comparator simultaneously, further tunable delay lines 612 are arranged also between a clock circuit 613 and comparators 607 to 610.

The receiver of the invention can be implemented as a multi-user frequency hopping OCDMA receiver such that the received signals are first separated into frequency pulses to their own branches by using frequency-selective components. In the case of the examples at issue, the received signal is divided into four frequency pulses by using three frequency-selective components. Each branch corresponds to a frequency pulse in a particular frequency band. Each branch comprises a photodiode for further converting the frequency pulse into a pulse-mode electrical signal. The same frequency-selective components and photodiodes are used for receiving the signals of more than one user.

The pulse-mode electrical signal is further divided between N branches, wherein N is the number of users. Electrical delay lines are used for decoding each divided signal to a correct user according to the coding used. The signal pulses are received by comparators, which are used for comparing the magnitude of a pulse to a predetermined threshold value. The operation of the comparators can be controlled by a separate control circuit (clock). If the magnitude of the pulse exceeds the threshold value, a digital signal representing the 1-bit is transmitted to the decision circuit; otherwise, a signal representing the 0-bit is transmitted. Each signal of the user is converted into a digital symbol, i.e. 0-bit or 1-bit, in the decision circuit, which makes a decision about the symbol on the basis of the received signals. If all received signals represent the 1-bit, the decision circuit provides its output with a 1-bit. If at least one received bit or preferably all received bits represent the 0-bit, the decision circuit provides its output with a 0-bit. Since the signals are not divided in an optical form but in an electrical form, possible losses caused by dividing an optical signal can be avoided.

Another alternative way to implement decoding is to arrange the tunable delay lines between the comparators and the decision circuit. Since in this case the frequency pulses do not arrive at the comparator simultaneously, other tunable delay lines have also been arranged between the clock circuit and the comparators.

The method and device of the invention can be used e.g. in OOK and PPM signalling and in optical frequency hopping CDMA systems.

The implementation and embodiments of the invention are disclosed herein by means of examples. It is obvious to one skilled in the art that the invention is not restricted to the details of the embodiments disclosed above and that the invention can also be implemented in another form without deviating from the characteristics of the invention. The disclosed embodiments should be regarded as illustrative but not restrictive. Feasible embodiments and potential uses of the invention are thus only restricted by the attached claims. The different embodiments, including equivalent implementations, of the invention defined by the claims thus fall within the scope of the invention.

1. A method for generating an output bit value from a received optical pulse sequence comprising at least two pulse components with different frequencies, characterized in that the method comprises
dividing said optical pulse sequence to at least two different frequency bands, each frequency band comprising at least one frequency pulse component from said optical pulse,
converting the frequency pulse component of each frequency band into an electrical pulse,
generating a bit value for each frequency band on the basis of the magnitude of the electrical pulse, and
deciding the value of a received output bit on the basis of the bit value of each frequency band.

2. A method as claimed in claim 1, characterized in that the method further comprises dividing said optical pulse sequence to at least one user.

3. A method as claimed in claim 1, characterized in that the method further comprises dividing said optical frequency pulse components to at least one user.

4. A method as claimed in claim 1, characterized in that the method further comprises dividing said electrical pulses to at least one user.

5. A method as claimed in claims 2 to 4, characterized in that for each user the method comprises:
dividing said optical pulse sequence to at least two different frequency bands, each frequency band comprising at least one parallel frequency pulse component from said optical pulse,
converting the frequency pulse component of each frequency band into an electrical pulse,
synchronizing the electrical pulse of each frequency band with the same moment in the time domain,
comparing, separately, the magnitude of the electrical pulse of each frequency band to the magnitude of a predetermined threshold value,
generating a bit value for each frequency band in response to the comparison conducted, and
deciding the value of a received output bit on the basis of the bit value of each frequency band.

6. A method as claimed in claim 5, characterized in that the method further comprises synchronizing the pulse of each frequency band with the same moment in the time domain.

7. A method as claimed in claim 6, characterized in that said synchronization is performed on the optical frequency pulse components.

8. A method as claimed in claim 6, characterized in that said synchronization is performed on the electrical pulses generated by photodiodes.

9. A method as claimed in claim 6, characterized in that said synchronization is performed on the signals generated after said first comparison.

10. A method as claimed in claim 5, 7, 8 or 9, characterized in that the method further comprises compensating for phase deviation of the frequency pulse components by delaying each frequency pulse component in order to minimize the phase deviation.

11. A method as claimed in claim 10, characterized in that said compensation is performed on the optical frequency pulse components.

12. A method as claimed in claim 10, characterized in that said compensation is performed on the electrical pulses generated by photodiodes.

13. A method as claimed in claim 10, characterized in that said compensation is performed on the signals generated by comparators.

14. A method as claimed in claim 10, characterized in that said compensation is also performed on synchronization of comparators.

15. An electronic device for generating an output bit value from a received optical pulse sequence comprising at least two pulse components with different frequencies, characterized in that the device comprises
division means for dividing said optical pulse sequence to at least two different frequency bands, each frequency band comprising at least one frequency pulse component from said optical pulse,
conversion means for converting the frequency pulse component of each frequency band into an electrical pulse,
first comparison means for comparing the magnitude of the electrical pulse of each frequency band to the magnitude of a predetermined threshold value,
generation means for generating a bit value for each frequency band in response to the comparison conducted, and
decision means for generating the value of a received output bit on the basis of the bit value of each frequency band.

16. A device as claimed in claim 15, characterized in that the device further comprises second comparison means for performing a second comparison to compare the generated bit values of all frequency bands with each other at the same moment.

17. A device as claimed in claim 15, characterized in that the device further comprises division means for dividing said optical pulse sequence to at least one user.

18. A device as claimed in claim 15, characterized in that the device further comprises division means for dividing said optical frequency components to at least one user.

19. A device as claimed in claim 15, characterized in that the device further comprises division means for dividing said electrical pulses to at least one user.

20. A device as claimed in claims 16 to 19, characterized in that the device further comprises for each user:
division means for dividing said optical pulse sequence to at least two different frequency bands, each frequency band comprising at least one parallel frequency pulse component from said optical pulse,
conversion means for converting the frequency pulse component of each frequency band into an electrical pulse,
first comparison means for comparing the magnitude of the electrical pulse of each frequency band to the magnitude of a predetermined threshold value,
generation means for generating a bit value for each frequency band in response to the comparison conducted, and
decision means for generating the value of a received output bit on the basis of the bit value of each frequency band.

21. A device as claimed in claim 20, characterized in that the device further comprises synchronization means for synchronizing the pulse of each frequency band with the same moment in the time domain.

22. A device as claimed in claim 21, characterized in that said synchronization means are implemented to perform said synchronization on the optical frequency pulse components.

23. A device as claimed in claim 21, characterized in that said synchronization means are implemented to perform said synchronization on the electrical pulses generated by photodiodes.

24. A device as claimed in claim 21, characterized in that said synchronization means are implemented to perform the synchronization on the signals generated after said first comparison.

25. A device as claimed in claim 20, 22, 23 or 24, characterized in that the device further comprises first compensation means for compensating for the phase deviation between the frequency pulses with respect to time.

26. A device as claimed in claim 25, characterized in that said first compensation means are implemented to perform said compensation on the electrical pulses generated by photodiodes.

27. A device as claimed in claim 25, characterized in that said first compensation means are implemented to perform said compensation on the signals generated by comparators.

28. A device as claimed in claim 27, characterized in that the device further comprises a comparator synchronizer for synchronizing said comparators with each other.

29. A device as claimed in claim 28, characterized in that the device further comprises second compensation means implemented to perform compensation on the comparator synchronizer.
